(19) United States
(12) Patent Application Publication
(10) Pub. No.: US 2004/0003619 A1
(43) Pub. Date: Jan. 8, 2004

(54) Surface treatment method for improving the surface wettability of wet surface heat exchangers

(76) Inventors: Dae Young Lee, Seoul (KR); Jae Beom Byun, Seoul (KR)

Correspondence Address: HARNESS, DICKEY & PIERCE, P.L.C., P.O. BOX 828, BLOOMFIELD HILLS, MI, 48303, US

(21) Appl. No.: 10/615,327

(22) Filed: Jul. 8, 2003

(30) Foreign Application Priority Data
Jul. 8, 2002 (KR) 10-2002-0039406

(51) Int. Cl. F28D 1/00; A23C 3/04; F28C 1/00; F28F 13/18; F28F 19/02; F28D 5/00

(52) U.S. Cl. 62/305; 62/121; 165/133; 165/DIG. 171; 165/115

(57) ABSTRACT

The present invention relates to the methods for hydrophilization, capable of greatly improving the surface wettability of wet surface heat exchangers by transforming the solid surface to an improved surface having hydrophilic porous structure.

In order to form the hydrophilic porous structure on the surface, the present invention provides two methods. One method consists of the operations of making the coating composition by blending micro solid particles with the hydrophilic binders; spreading the coating composition onto the surface of a heat exchanger by means of spraying or dipping; and curing the coated surface of a heat exchanger.

Another method to build the hydrophilic porous structure consists of the operation of roughening the surface of the heat exchanger by corroding the surface chemically or electrochemically, or by use of the physical process; and processing hydrophilization of the surface of said heat exchanger.

### BACKGROUND OF THE INVENTION

1. Field of the Invention

The present invention relates generally to the surface treatment methods for improving the surface wettability of heat exchangers. In more detail, it relates to the methods for hydrophilization, capable of greatly improving the surface wettability of wet surface heat exchangers including a cooling tower, an evaporative condensing unit, and an evaporative cooling unit by transforming the solid surface to an improved surface having hydrophilic porous structure.

2. Description of the Related Art

A wet surface heat exchanger as shown in FIG. 1 is implementing the evaporative cooling technology which allows the liquid inside of a heat exchanger(1) to be cooled by vaporizing the water(4) sprayed on the surface(2) of a heat exchanger. Reference number (3) in FIG. 1 denotes the water supply unit and number (5) the flow direction of the air. The wet surface heat exchangers can lead to the improved cooling performance, compared with the conventional heat exchangers which employ only the temperature difference in cooling.

The wet surface heat exchangers have been developed in various application domains including a cooling tower, an evaporative condensing unit, and an evaporative cooling unit. Nevertheless, practical usage of the wet surface heat exchangers has been quite limited despite the large volume of the prior art directed to this technology and its prominent cooling performance.

The fundamental cause of the limited usage relates to the surface wettedness. In the conventional wet surface heat exchangers, because the water(4) sprayed onto the surface(2) of a heat exchanger can not form a thin film, but form water droplets(6) as shown in FIG. 2, or flows down along the surface of a heat exchanger, the surface wettedness is low and thus the actual amount of the water evaporation is small. Therefore the evaporative cooling performance is much lower than expectation.

It is well known that the amount of water supplied is generally kept larger than the evaporated actually for improving the surface wettedness. However, the liquid supplied excessively increases the flow resistance and the pressure loss in the air side, thereby reducing the total amount of the air flowage. In worst case, the cooling performance reduction by decrease of the air flowage is greater than the cooling performance improvement by the evaporative cooling, thereby decreasing the overall cooling performance of a heat exchanger.

Several prior arts disclose the techniques related to wet surface heat exchangers. The processes for hydrophilization of the surface of a heat exchanger, which are applied to the evaporator of an air conditioner, are proposed in U.S. Pat. No. 5,813,452 and U.S. Pat. No. 6,368,671B1, and are designed for the condensed water of the surface to flow down well along the surface of an evaporator.

Although the contact angle of the water droplet is reduced by hydrophilization of the surface of a wet surface heat exchanger, the sprayed water flows as a form of rivulet along the inclined surface instead of forming the thin water film. Therefore, the techniques disclosed above may not improve the surface wettedness.

Furthermore, the techniques for improving wettability by processing grooves on the surface of a heat exchanger (U.S. Pat. No. 4,461,733 and U.S. Pat. No. 4,566,290), or by attaching absorptive material to the surface (U.S. Pat. No. 6,101,823 and U.S. Pat. No. 6,286,325B1) have disadvantages: it is possible to apply to a heat exchanger having only simple configuration, but not possible to apply to a conventional heat exchanger having complex configuration with a lot of fins for extended surface area.

Furthermore, water supply units, which can spray mist uniformly over the surface of a heat exchanger, are shown in U.S. Pat. No. 4,933,117 and U.S. Pat. No. 5,377,500, U.S. Pat. No. 5,605,052, and U.S. Pat. No. 5,701,748.

Because the mist spray unit as mentioned above uses a fine nozzle with a small diameter for spraying the mist uniformly over the surface, it has shown some disadvantages: the spray unit needs a high-pressure pump to discharge the water, and the spray nozzle tends to be clogged by contamination.

In addition, although water droplets are sprayed uniformly over the surface of a heat exchanger which is exposed directly to a water supply unit, if the surface is not hydrophilic, the water stays on the surface as droplets resulting an increase in the pressure loss, if the surface is hydrophilic, the water flows down as a form of rivulet. Consequently the surface wettedness is not improved greatly.

### SUMMARY OF THE INVENTION

The present invention relates generally to the surface treatment methods for improving the surface wettability of heat exchangers. In more detail, it relates to the methods for hydrophilization, capable of greatly improving the surface wettability of wet surface heat exchangers including a cooling tower, an evaporative condensing unit, and an evaporative cooling unit.

The present invention provides the surface treatment methods, which transform a solid surface into the improved surface having hydrophilic porous structure by coating the hydrophilic porous layer on the surface of a heat exchanger, or by roughening the surface of a heat exchanger and then applying hydrophilic treatment to the surface. The surface treatment improves greatly the surface wettability by improving the water spread with the aid of the capillary force acting in the porous structure, and holding the water within the porous structure of the surface. The surface treatment methods can be implemented to any kinds of heat exchangers regardless of their configuration.

### BRIEF DESCRIPTION OF THE DRAWINGS

FIG. 1 is a schematic drawing depicting a wet surface heat exchanger.

FIG. 2 is a diagram illustrating the water droplet distribution on the surface of the conventional heat exchangers.

FIG. 3 is a diagram showing the surface treatment result after coating the surface using the composition of solid particles and hydrophilic binders in accordance with the present invention.

FIG. 4 is a microphotograph illustrating the surface having the porous structure that is formed by utilizing the composition of solid particles and hydrophilic binders in accordance with the present invention.

FIG. 5 is a microphotograph illustrating the surface state that is formed by the binder having excessively high viscosity.

FIG. 6 is a microphotograph illustrating the surface state that is formed by the binder having proper viscosity in accordance with the present invention.

FIG. 7 is a microphotograph illustrating the surface having the porous structure that is formed by utilizing the surface roughening and thereafter hydrophilization process in accordance with the present invention.

FIG. 8 is a microphotograph illustrating the improved dispersion of the evaporation water owing to the surface treatment for the hydrophilic porous structure in accordance with the present invention.

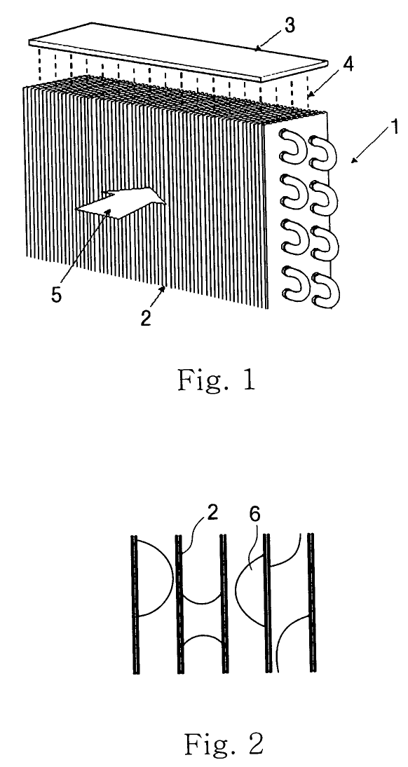

### DETAILED DESCRIPTION OF THE EMBODIMENTS

Hereinafter, referring to appended drawings, the structures and the operation procedures of the embodiments of the present invention are described in detail.

In the present invention, so as to build the hydrophilic porous structure on the surface, the methods for treatment of the surface of a heat exchanger can be classified into two methods.

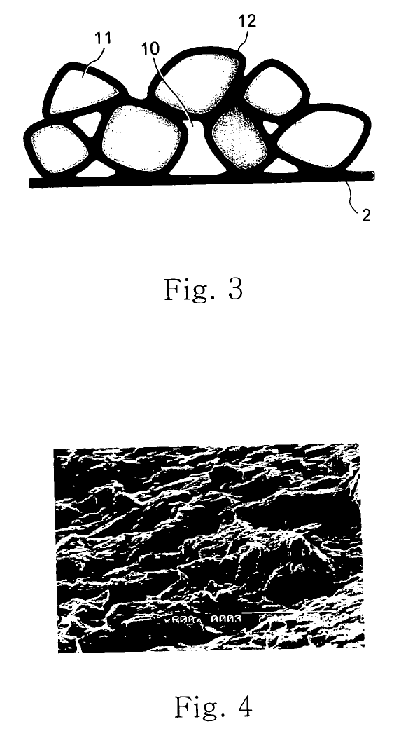

The first method shown in FIG. 3 is a so-called coating method, which is comprising of the operations of making the coating composition by blending micro solid particles with the hydrophilic binders; spreading the coating composition on the surface of a heat exchanger by means of spraying or dipping; and curing the coated surface of a heat exchanger, thereby transforming a solid surface into the improved surface having the hydrophilic porous structure.

FIG. 4 is a microphotograph, magnified 800 times, illustrating the surface that is treated by the first method. When the size of pores(10) in the porous structure is too small, the water may not penetrate into the porous structure due to the surface tension of water, meanwhile when the size of pores is too large, the dispersion of evaporation water becomes low because of the small capillary force. Therefore, the size of pores(10) of the porous structure should be controlled properly.

The most influencing factor to the size of pores relates to the size of the solid particles. Average particle diameter of 5˜100 μm is suitable and the particles with uniform diameter is advantageous. The more uniform the particle diameter is, the larger the porosity is, which results in larger amount of water retained in the porous structure.

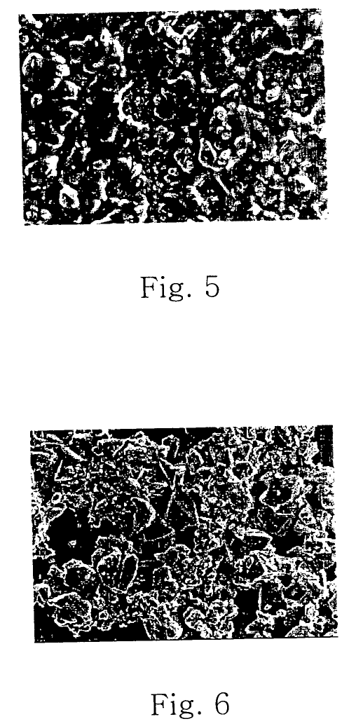

If the viscosity of the hydrophilic binder is too high, the solid particles are buried in the binder as shown in FIG. 5. Consequently the gap between the solid particles is filled with binder, so that the porous structure is not obtained after curing process. Meanwhile, if the viscosity of the hydrophilic binder is too low, the coating layer is not formed because the sprayed binder flows down along the surface of a heat exchanger. The viscosity of binder can be adjusted by controlling the amount of the solvent.

FIG. 6 is a microphotograph illustrating the surface state that is formed by the binder having proper viscosity in accordance with the present invention.

If the thickness of the coating is too thin, substantial amount of evaporation water may not be stored within the porous structure. Meanwhile if the thickness of the coating is too thick, the flow passage of the air is reduced causing an increase in the pressure loss and the thermal resistance across the coating is increased, thereby decreasing the effectiveness of the evaporating cooling. The thickness of coating can be adjusted also by controlling the viscosity of binder.

The second method is a so-called roughening method, in which the surface of a heat exchanger is corroded by use of chemical or electrochemical processes, or roughened by use of physical processes, and, thereafter, is treated to have hydrophilic characteristics.

The practical methods for increasing the surface roughness are the chromate process as a chemical method, the anodizing process as an electrochemical method, and the sand blasting process as a physical method.

FIG. 7 is microphotograph, magnified 800 times, illustrating the surface that is treated by the second method. The height of surface roughness (similar to the size of pores of the porous structure in the first method) is the most influencing factor to the surface wettability, and the surface roughness of 5˜100 μm is the most suitable.

In the hydrophilization process to coat the hydrophilic resin on the surface after increasing surface roughness, if the viscosity of the hydrophilic resin is too high, the roughness is covered with the resin partially or completely, and then the surface roughness after the treatment decrease. Therefore it is required to adjust the viscosity of resin by controlling the ratio of the hydrophilic resin and solvent.

In above-mentioned surface treatment method, which coats the porous layer on the surface, the types of solid particles and hydrophilic binders are not limited or restricted.

Furthermore, in above-mentioned surface treatment method, which hydrophilizes the surface after increasing the surface roughness, the types of hydrophilization method and roughness increasing method are not limited or restricted.

In the method for transforming the surface of a heat exchanger to have the hydrophilic porous structure, one method is to build the hydrophilic porous structure on the surfaces of each components of a heat exchanger first and thereafter assemble the components to construct a heat exchanger. Another method is to build the hydrophilic porous structure on the surface of a heat exchanger, which is assembled in advance. There is no limitation or restriction in the sequence of assembling and treatment.

It is also possible to embody a desirable combination of corrosion resistant treatment and antibacterial treatment with the hydrophilic porous treatment.

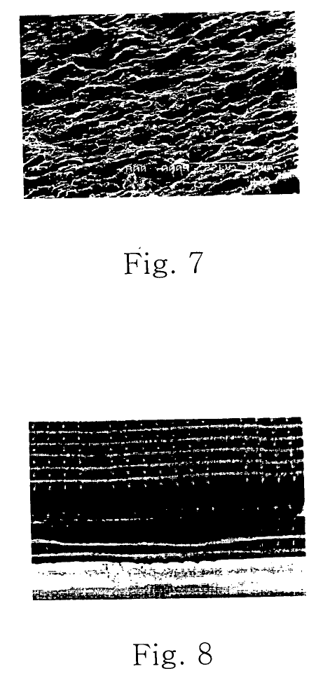

FIG. 8 is a microphotograph illustrating the performance of the preferred embodiment. The water droplet laid on the treated surface is shown to spread widely along the surface to form a thin water film due to the hydrophilic and porous nature of the surface. Accordingly the surface wettedness of wet surface heat exchangers is greatly improved by utilizing the hydrophilic surface treatments.

As seen above, with the surface treatment in accordance with the present invention, the water spreads widely on the surface of a heat exchanger to form a thin water film resulting in an increase in the water evaporation, thereby improving the cooling effectiveness of a wet surface heat exchanger. Also, an increase in the pressure loss by spraying the evaporation water is nearly zero because the flow resistance due to the sprayed water is reduced to minimum.

Furthermore, it is possible to remove the pump and peripheries for recirculating the evaporation water because the surface of a heat exchanger can be covered completely by thin water film only with the small amount of water which is actually vaporized. Consequently the wet surface heat exchanger can be made simple in structure and compact in size, and the maintenance cost can be minimized.

Furthermore, although the evaporation water is dispersed only at a part of the surface, the thin water film develops to cover the whole surface because of the excellent dispersion characteristics of the treated surface in accordance with the present invention, thereby simplifying the water supply unit.

Since those having ordinary knowledge and skill in the art of the present invention will recognize additional modifications and applications within the scope thereof, the present invention is not limited to the embodiments and drawings described above.

What is claimed is:

1. A process for treating the surface of a wet surface heat exchanger so as to build the hydrophilic porous structure,
said process comprising the operation of:
making the coating composition by blending micro solid particles with the hydrophilic binders;
spreading said coating composition on the surface of said heat exchanger by means of spraying or dipping; and
curing the coated surface of said heat exchanger.

2. A process for treating the surface of a wet surface heat exchanger according to claim 1, wherein said micro solid particles is 5˜100 μm in diameter.

3. A process for treating the surface of a wet surface heat exchanger according to claim 1, wherein the thickness of the hydrophilic porous structure coating on said surface of a heat exchanger is adjusted by controlling the viscosity of binder.

4. A process for treating the surface of a wet surface heat exchanger so as to build the hydrophilic porous structure,
said process comprising the operation of:
roughening the surface of said heat exchanger by corroding said surface with chemical or electrochemical process, or by use of the physical process; and
processing hydrophilization of said surface of said heat exchanger.

5. A process for treating the surface of a wet surface heat exchanger according to claim 4, wherein said surface roughness is 5˜100 μm in height.

6. A process for treating the surface of a wet surface heat exchanger according to claim 1, wherein the method for building the hydrophilic porous structure on the surface of said heat exchanger is:
building said hydrophilic porous structure on the surface of each components of a heat exchanger, thereafter assembling each components to construct a heat exchanger; or
building said hydrophilic porous structure on the surface of a heat exchanger which is assembled in advance.

7. A process for treating the surface of a wet surface heat exchanger according to claim 4, wherein the method for building the hydrophilic porous structure on the surface of said heat exchanger is:
building said hydrophilic porous structure on the surface of each components of a heat exchanger, thereafter assembling each components to construct a heat exchanger; or
building said hydrophilic porous structure on the surface of a heat exchanger which is assembled in advance.
